(19) United States
(12) Patent Application Publication
(10) Pub. No.: US 2006/0100310 A1
(43) Pub. Date: May 11, 2006

(54) Image forming method, and set of ink compositions and image forming apparatus, which are applicable to the image forming method

(75) Inventors: Ikuo Nakazawa, Kawasaki-shi (JP); Koichi Sato, Atsugi-shi (JP); Ryuji Higashi, Kawasaki-shi (JP); Sakae Suda, Yokohama-shi (JP); Masayuki Ikegami, Atsugi-shi (JP); Keiichiro Tsubaki, Kawasaki-shi (JP); Keiko Yamagishi, Ebina-shi (JP); Youhei Miyauchi, Kawasaki-shi (JP); Tomoya Oku, Atsugi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/312,513

(22) Filed: Dec. 21, 2005

Related U.S. Application Data
(63) Continuation-in-part of application No. 10/557,236.

(30) Foreign Application Priority Data
Mar. 5, 2004 (JP) 2004-062968
Dec. 27, 2004 (JP) 2004-376606
Nov. 25, 2005 (JP) 2005-341119

(51) Int. Cl. C03C 17/00; C09D 11/00

(52) U.S. Cl. 523/160; 523/161

(57) ABSTRACT

In an image forming method in which at least two kinds of ink compositions are applied onto a recording medium to form an image on the recording medium, the image forming method has the steps of providing a first ink composition containing a solvent, a coloring material and a block polymer having at least an anionic block segment for dispersing the pigment in the solvent, and a second ink composition containing a solvent, a dye and a polyvalent metal ion having reactivity with the block polymer; and applying the first ink composition and the second ink composition onto the recording medium to bring the first ink composition into contact with the second ink composition.

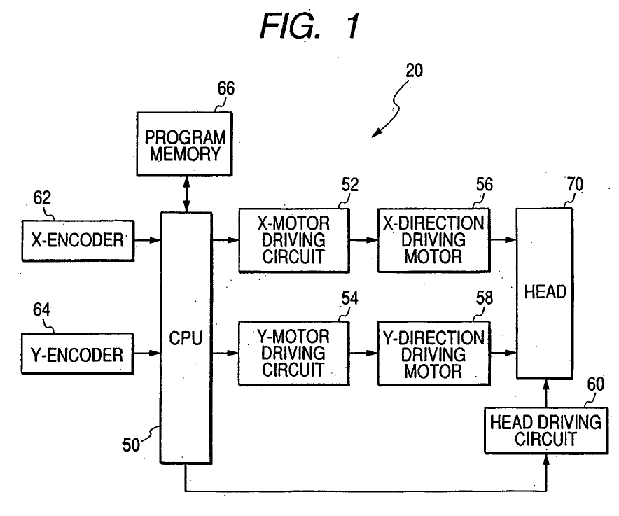

This application is a continuation-in-part of application Ser. No. 10/557,236 filed on Nov. 17, 2005, which is the National Stage of International Application No. PCT/JP2005/004031, filed on Mar. 2, 2005.

### BACKGROUND OF THE INVENTION

1. Field of the Invention

This invention relates to an image forming method, by which fixing performance on a recording medium is improved, and occurrence of blurring between fixed areas is prevented, and a set of ink compositions and an apparatus, which are used in the image forming method.

2. Related Background Art

In recent years, digital printing technique is making very dramatic progress. This digital printing technique is, as its typical example, what is called electrophotographic technique or ink-jet technique, and is more and more making its presence felt as image forming technique in offices, homes and so forth.

In particular, the ink jet technique has great characteristic features that it can enjoy compactness and low power consumption as a direct recording method. Also, image quality is being rapidly made higher as nozzles are made finer. An example of the ink jet technique is a method in which an ink fed from an ink tank is heated with heaters in nozzles to cause evaporation to bubbling, whereupon the ink is ejected to form images on a recording medium. Another example is a method in which the ink is ejected from nozzles by vibrating piezoelectric elements.

As inks used in such methods, aqueous dye solutions are usually used, and hence in some cases, blurring may occur when they are superimposed, or a phenomenon called feathering may come in the direction of fibers of paper at recorded areas on a recording medium. Also, since dyes are chiefly used as coloring materials, it is earnestly demanded to improve weatherability. It is further demanded to improve scratch resistance. For the purpose of making improvements on these properties, an example is found in which the reaction of a dye ink with a pigment ink is utilized (U.S. Pat. No. 5,320,668). An example is also found in which a reactive self-dispersible pigment is used (U.S. Pat. No. 6,281,267). Further, U.S. Pat. No. 5,428,383 discloses a method in which a first ink containing a first colorant is brought into contact with a second ink containing a second colorant and a polyvalent metal salt to form precipitate, thereby preventing blurring. This U.S. Pat. No. 5,428,383 discloses the use of pigments, but does not disclose anything about polymers for dispersing such a pigment. The techniques disclosed in these U.S. patent documents are not the desirable best techniques, but further improvements are demanded under the circumstances.

### SUMMARY OF THE INVENTION

The present invention has been made taking account of such background technique, and intends to provide an image forming method, by which occurrence of blurring is prevented when inks are applied by bringing them into contact with each other, and drying time can be shortened, and a set of ink compositions and an image forming apparatus, which are applicable to the image forming method.

The present invention also intends to provide a method capable of forming good images on a recording medium by using two or more kinds of ink compositions different in properties and by bringing such ink compositions into contact with one another to cause the ink compositions to thicken.

The image forming method provided by the present invention is an image forming method, in which at least two kinds of ink compositions are applied onto a recording medium to form an image on the recording medium; the method comprising the steps of:

providing a first ink composition containing a solvent, a coloring material and a block polymer having at least an anionic block segment for dispersing the coloring material in the solvent, and a second ink composition containing a solvent, a dye and a polyvalent metal ion having reactivity with the block polymer; and

applying the first ink composition and the second ink composition onto the recording medium to bring the first ink composition into contact with the second ink composition.

The ink set provided by the present invention is an ink set for applying at least two kinds of ink compositions onto a recording medium to form an image on the recording medium, the ink set comprising:

a first ink composition containing a solvent, a coloring material and a block polymer having at least an anionic block segment for dispersing the coloring material in the solvent; and

a second ink composition containing a solvent, a dye and a polyvalent metal ion having reactivity with the block polymer.

The image forming apparatus further provided by the present invention comprises:

an ink-applying means for causing energy to act on each of a first ink composition containing a solvent, a coloring material and a block polymer having at least an anionic block segment for dispersing the coloring material in the solvent, and a second ink composition containing a solvent, a dye and a polyvalent metal ion having reactivity with the block polymer to apply the ink compositions to a recording medium, thereby forming an image; and

a driving means for driving the ink-applying means.

According to the present invention, the occurrence of blurring between fixed areas of inks of different colors upon recording of a multi-color image can be prevented, and drying time can be shortened to form the image.

### BRIEF DESCRIPTION OF THE DRAWING

FIGURE is a block diagram showing the construction of an exemplary ink-jet recording apparatus.

### DESCRIPTION OF THE PREFERRED EMBODIMENTS

The image forming method of the present invention is an image forming method, in which at least two kinds of ink compositions are applied onto a recording medium to form an image on the recording medium; the method comprising the steps of:

providing a first ink composition containing a solvent, a coloring material and a block polymer having at least an anionic block segment for dispersing the coloring material in the solvent, and a second ink composition containing a solvent, a dye and a polyvalent metal ion having reactivity with the block polymer; and

applying the first ink composition and the second ink composition onto the recording medium to bring the first ink composition into contact with the second ink composition.

As the block polymer adopted in the present invention, may be used that having a polyalkenyl ether backbone chain in its repeating structural unit. The block polymer may have at least 2 or 3 block segments. The coloring material can be enclosed by the block polymer. The block polymer may have a repeating structural unit exhibiting hydrophilicity. The block polymer may also exhibit amphiphilicity.

As the repeating structural unit having the polyvinyl ether backbone chain in the present invention, may be used a structure represented by the following general formula (1):
—(CRₐR_{b}—CR_{c}(OR₁)) (1)
wherein Rₐ, R_{b} and R_{c} are, independently of one another, H or CH₃, and R₁ represents a straight-chain, branched or cyclic alkyl group having 1 to 18 carbon atoms, or is selected from —(CH(R₂)—CH(R₃)—O)₁—R₄ and —(CH₂)ₘ—(O)ₙ—R₄; where 1 and m are, independently of each other, selected from integers of 1 to 12, n is 0 or 1, R₂ and R₃ are, independently of each other, H or CH₃, and R₄ represents H, a straight-chain, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR₅, -PhCOOR₅ or —R₆COOR₅, with the proviso that when R₄ is other than a hydrogen atom, a hydrogen atom on a carbon atom may be replaced by a straight-chain or branched alkyl group having 1 to 4 carbon atoms, and a carbon atom in the aromatic ring may be replaced by a nitrogen atom, R₅ is H, Na or K, and R₆ is a polycyclic aromatic substituent group.

In the present invention, the first and second ink compositions may be applied to the recording medium using an ink-jet system.

The present invention also embraces an ink set for applying at least two kinds of ink compositions onto a recording medium to form an image on the recording medium.

The ink set according to the present invention comprises a first ink composition containing a solvent, a coloring material and a block polymer having at least an anionic block segment for dispersing the coloring material in the solvent, and a second ink composition containing a solvent, a dye and a polyvalent metal ion having reactivity with the block polymer.

The present invention further embraces an image forming apparatus.

The image forming apparatus according to the present invention comprises:

an ink-applying means for causing energy to act on each of a first ink composition containing a solvent, a coloring material and a block polymer having at least an anionic block segment for dispersing the coloring material in the solvent, and a second ink composition containing a solvent, a dye and a polyvalent metal ion having reactivity with the block polymer to apply the ink compositions to a recording medium, thereby forming an image; and

a driving means for driving the ink-applying means.

A coloring material used in the first ink composition in the present invention includes pigments. The pigments include inorganic achromatic pigments, and organic or inorganic chromatic pigments. Colorless or pale-color pigments, metalescent pigments or the like may also be used. Also usable are pigments newly synthesized for the sake of the present invention.

Examples of the pigments include the following pigments.

As black pigments, may be mentioned RAVEN 1060, RAVEN 1080, RAVEN 1170, RAVEN 1200, RAVEN 1250, RAVEN 1500, RAVEN 2000, RAVEN 3500, RAVEN 5250, RAVEN 5750, RAVEN 7000, RAVEN 5000, ULTRA II and RAVEN 1190 ULTRA II (the foregoing are available from Columbian Carbon Corp.); BLACK PEARLS L, MOGUL-L, REGAL 400R, REGAL 660R, REGAL 330R, MONARCH 800, MONARCH 880, MONARCH 900, MONARCH 1000, MONARCH 1300 and MONARCH 1400 (the foregoing are available from Cabot Corp.); COLOR BLACK FW1, COLOR BLACK FW2, COLOR BLACK FW200, COLOR BLACK 18, COLOR BLACK S160, COLOR BLACK S170, SPECIAL BLACK 4, SPECIAL BLACK 4A, SPACIAL BLACK 6, PRINTEX 35, PRINTEX U, PRINTEX 140U, PRINTEX V and PRINTEX 140V (the foregoing are available from Degussa Corp.); and No. 25, No. 33, No. 40, No. 47, No. 52, No. 900, No. 2300, MCF-88, MA600, MA7, MA8 and MA100 (the foregoing are available from Mitsubishi Chemicals, Inc.). However, the pigments are not limited thereto.

As cyan pigments, may be mentioned C.I. Pigment Blue 1, C.I. Pigment Blue 2, C.I. Pigment Blue 3, C.I. Pigment Blue 15, C.I. Pigment Blue 15:2, C.I. Pigment Blue 15:3, C.I. Pigment Blue 15:4, C.I. Pigment Blue 16, C.I. Pigment Blue 22 and C.I. Pigment Blue 60. However, the pigments are not limited thereto.

As magenta pigments, may be mentioned C.I. Pigment Red 5, C.I. Pigment Red 7, C.I. Pigment Red 12, C.I. Pigment Red 48, C.I. Pigment Red 48:1, C.I. Pigment Red 57, C.I. Pigment Red 112, C.I. Pigment Red 122, C.I. Pigment Red 123, C.I. Pigment Red 146, C.I. Pigment Red 168, C.I. Pigment Red 184, C.I. Pigment Red 202 and C.I. Pigment Red 207. However, the pigments are not limited thereto.

As yellow pigments, may be mentioned C.I. Pigment Yellow 12, C.I. Pigment Yellow 13, C.I. Pigment Yellow 14, C.I. Pigment Yellow 16, C.I. Pigment Yellow 17, C.I. Pigment Yellow 74, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 128, C.I. Pigment Yellow 129, C.I. Pigment Yellow 151 and C.I. Pigment Yellow 154. However, the pigments are not limited thereto.

For the present invention fat-soluble (oil-soluble) dyes, or insoluble dyes such as disperse dyes as well as pigments may also be used. The dyes may also be used in solid state. Examples thereof include C.I. Solvent Blue 33, 38, 42, 45, 53, 65, 67, 70, 104, 114, 115, 135; C.I. Solvent Red 25, 31, 86, 92, 97, 118, 132, 160, 186, 187, 219; and C.I. Solvent Yellow 1, 49, 62, 74, 79, 82, 83, 89, 90, 120, 121, 151, 153, 154.

A coloring material used in the second ink composition is a dye, and usable dyes may be known ones or novel ones.

Examples thereof include water-soluble dyes such as direct dyes, acid dyes, basic dyes, reactive dyes and food dyes, which are as described below. The water-soluble dyes are particularly preferred.

Examples thereof include direct dyes such as C.I. Direct Black 17, 19, 22, 32, 38, 51, 62, 71, 108, 146, 154; C.I. Direct Yellow 12, 24, 26, 44, 86, 87, 98, 100, 130, 142; C.I. Direct Red 1, 4, 13, 17, 23, 28, 31, 62, 79, 81, 89, 227, 240, 242, 243; C.I. Direct Blue 6, 22, 25, 71, 78, 86, 90, 106, 199; C.I. Direct Orange 34, 39, 44, 46, 60; C.I. Direct Violet 47, 48; C.I. Direct Brown 109; and C.I. Direct Green 59; acid dyes such as C.I. Acid Black 2, 7, 24, 26, 31, 52, 63, 112, 118, 168, 172, 208; C.I. Acid Yellow 11, 17, 23, 25, 29, 42, 49, 61, 71; C.I. Acid Red 1, 6, 8, 32, 37, 51, 52, 80, 85, 87, 92, 94, 115, 180, 254, 256, 289, 315, 317; C.I. Acid Blue 9, 22, 40, 59, 93, 102, 104, 113, 117, 120, 167, 229, 234, 254; C.I. Acid Orange 7, 19; and C.I. Acid Violet 49; basic dyes such as Chrysoidine and Methylene Blue (C.I. Basic Blue 9); reactive dyes such as C.I. Reactive Black 1, 5, 8, 13, 14, 23, 31, 34, 39; C.I. Reactive Yellow 2, 3, 13, 15, 17, 18, 23, 24, 37, 42, 57, 58, 64, 75, 76, 77, 79, 81, 84, 85, 87, 88, 91, 92, 93, 95, 102, 111, 115, 116, 130, 131, 132, 133, 135, 137, 139, 140, 142, 143, 144, 145, 146, 147, 148, 151, 162, 163; C.I. Reactive Red 3, 13, 16, 21, 22, 23, 24, 29, 31, 33, 35, 45, 49, 55, 63, 85, 106, 109, 111, 112, 113, 114, 118, 126, 128, 130, 131, 141, 151, 170, 171, 174, 176, 177, 183, 184, 186, 187, 188, 190, 193, 194, 195, 196, 200, 201, 202, 204, 206, 218, 221; C.I. Reactive Blue 2, 3, 5, 8, 10, 13, 14, 15, 18, 19, 21, 25, 27, 28, 38, 39, 40, 41, 49, 52, 63, 71, 72, 74, 75, 77, 78, 79, 89, 100, 101, 104, 105, 119, 122, 147, 158, 160, 162, 166, 169, 170, 171, 172, 173, 174, 176, 179, 184, 190, 191, 194, 195, 198, 204, 211, 216, 217; C.I. Reactive Orange 5, 7, 11, 12, 13, 15, 16, 35, 45, 46, 56, 62, 70, 72, 74, 82, 84, 87, 91, 92, 93, 95, 97, 99; C.I. Reactive Violet 1, 4, 5, 6, 22, 24, 33, 36, 38; C.I. Reactive Green 5, 8, 12, 15, 19, 23; and C.I. Reactive Brown 2, 7, 8, 9, 11, 16, 17, 18, 21, 24, 26, 31, 32, 33; and C.I. Basic Black 2; C.I. Basic Red 1, 2, 9, 12, 13, 14, 27; C.I. Basic Blue 1, 3, 5, 7, 9, 24, 25, 26, 28, 29; C.I. Basic Violet 7, 14, 27; C.I. Food Black 1, 2. Incidentally, these examples of the coloring materials described above are particularly preferred for the compositions according to the present invention. However, the coloring material used in the present invention is not particularly limited to the above coloring materials. The coloring material may preferably be contained in an amount of from 0.01 to 80% by mass based on the total mass of the first ink composition. In the case when two or more kinds of coloring materials are used, it is preferable for their total mass to be so set as to be within this range. If the coloring material is in an amount of less than 0.01% by mass, no more sufficient coloring may be achievable. If it is in an amount of more than 80% by mass, it may show a poor dispersibility. As a more preferable range, it may be in an amount ranging from 0.1% by mass to 50% by mass. As a still more preferable range, it may be in an amount ranging from 0.3% by mass to 30% by mass.

The block polymer compound used in the first ink composition according to the present invention may more preferably have a block form such as AC, ABA or ABC. A, B and C each represent a different block segment. In view of such an advantage that a good state of enclosure of the coloring material can be formed, an AC or ABC block polymer is preferred. The AC block polymer may be an amphiphilic di-block polymer compound in which hydrophobic and hydrophilic block segments are formed in the order of AC. An amphiphilic tri-block polymer compound that is an ABC block polymer, in which hydrophobic, hydrophilic and hydrophilic block segments are formed in the order of ABC, is more preferred. It is further preferable that, of such hydrophobic, hydrophilic and hydrophilic block segments, the B segment has nonionic hydrophilicity and the C segment has ionic hydrophilicity, and the block polymer is an anionic di-block or tri-block polymer compound in which the C segment is anionic.

Methods for synthesizing the block polymer compound having a polyalkenyl ether structure that may be used as the block polymer in the present invention are reported in a large number (see, e.g., Japanese Patent Application Laid-open No. H11-080221). Among these, a method by cationic living polymerization by Aoshima et al. (Polymer Bulletin Vol. 15, 1986, p. 417; Japanese Patent Applications Laid-open No. H11-322942 and No. H11-322866) is typical. Where polymers are synthesized by cationic living polymerization, homopolymers or copolymers composed of two or more monomer components and also various polymers such as block polymers, graft polymers and gradient polymers can be synthesized in lengths (molecular weights) uniformed accurately. Also, as to polyalkenyl ethers, various functional groups can be introduced into their side chains. Cationic polymerization may besides be carried out in an HI/I₂ system, an HCl/SnCl₄ system or the like.

The structure of the block polymer compound containing the polyalkenyl ether structure may also be a copolymer composed of a vinyl ether and any other polymer. However, the polyalkenyl ether structure may preferably be contained in a proportion of 90 mol % as a repeating structural unit. Preferably used is a block polymer composed of a repeating structural unit of a polyvinyl ether.

The ionic polymer used in inks in the present invention preferably has a repeating structural unit containing a polyvinyl ether structure, and an example thereof is represented by the following general formula (1):
—(CRₐR_{b}—CR_{c}(OR₁)) (1)
wherein Rₐ, R_{b} and R_{c} are, independently of one another, H or CH₃, and R₁ represents a straight-chain, branched or cyclic alkyl group having 1 to 18 carbon atoms, or is selected from —(CH(R₂)—CH(R₃)—O)₁—R₄ and —(CH₂)ₘ—(O)ₙ—R₄; where 1 and m are, independently of each other, selected from integers of 1 to 12, n is 0 or 1, R₂ and R₃ are, independently of each other, H or CH₃, and R₄ represents H, a straight-chain, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR₅, -PhCOOR₅ or —R₆COOR₅, with the proviso that when R₄ is other than a hydrogen atom, a hydrogen atom on a carbon atom may be replaced by a straight-chain or branched alkyl group having 1 to 4 carbon atoms, and a carbon atom in the aromatic ring may be replaced by a nitrogen atom, R₅ is H, Na or K, and R₆ is a polycyclic aromatic substituent group.

The repeating structural unit represented by the general formula (1) may preferably be used in each segment of the block polymer compound used preferably in the present invention.

The hydrophobic block segment of the amphiphilic block polymer compound used in the present invention preferably contains a repeating structural unit represented by the following general formula (2): 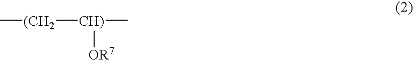
wherein R⁷ is selected from a straight-chain, branched or cyclic alkyl group having 1 to 18 carbon atoms, -Ph, -Pyr, -Ph-Ph, -Ph-Pyr, —(CH(R⁸)—CH(R⁹)—O)ₚ—R¹⁰ and —(CH₂)ₘ, (°)ₙ—R¹⁰, with the proviso that a hydrogen atom in an aromatic ring may be replaced by a straight-chain or branched alkyl group having 1 to 4 carbon atoms and a carbon atom in the aromatic ring may be replaced by a nitrogen atom; where p is an integers of 1 to 18, m is an integers of 1 to 36, n is 0 or 1, R⁸ and R⁹ are, independently of each other, a hydrogen atom or CH₃, and R¹⁰ is a straight-chain, branched or cyclic alkyl group having 1 to 18 carbon atoms, -Ph, -Pyr, -Ph-Ph, -Ph-Pyr, —CHO, —CO—CH═CH₂, —CO—C(CH₃)═CH₂ or —CH₂COOR¹¹, and, where a hydrogen atom bonded to a carbon atom may be replaced by a straight-chain or branched alkyl group having 1 to 4 carbon atoms, F, Cl or Br, and a carbon atom in the aromatic ring may be replaced by a nitrogen atom, and R¹¹ is an alkyl group having 1 to 4 carbon atoms.

In the present invention, -Ph, -Pyr, -Ph-Ph, -Ph-Pyr represent a phenyl group, a pyridyl group, a biphenyl group and a pyridylphenyl group, respectively. As to the pyridyl group, biphenyl group and pyridylphenyl group, these may be any of possible position isomers.

Specific examples of the repeating structural unit represented by the general formula (2) are mentioned below. However, the present invention is not limited by these. 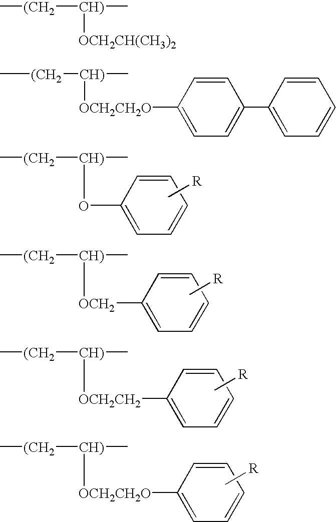
wherein R represents a hydrogen atom or a straight-chain or branched alkyl group having 1 to 4 carbon atoms.

The anionic repeating structural unit in the amphiphilic block polymer compound used in the present invention is preferably represented by the following general formula (3): 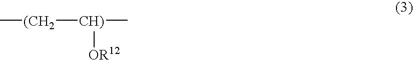
wherein R¹² represents —X—COO, where X represents a straight-chain, branched or cyclic alkylene group having 1 to 20 carbon atoms, or —(CH(R¹³)—CH(R¹⁴)—O)ₚ—(CH₂)ₘ— or —(CH₂)ₘ—(O)ₙ—(CH₂)_{q}— or a structure in which at least one of the methylene groups of these groups has been replaced by a carbonyl group or a monocyclic or polycyclic aromatic ring structure, p represents an integer of 1 to 18, m represents an integer of 1 to 36, n is 1 or 0, q represents an integer of 1 to 18, and R¹³ and R¹⁴ each represent an alkyl group, with the proviso that R¹³ and R¹⁴ may be the same or different from each other.

Specific examples of the anionic repeating structural unit represented by the general formula (3) are mentioned below. However, the present invention is not limited at all by these. 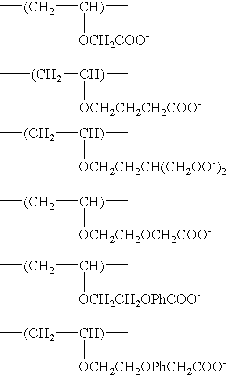
wherein -Ph and —Np represent a phenyl group and a naphthyl group, respectively.

The hydrophilic repeating structural unit in the amphiphilic block polymer compound used in the present invention is preferably represented by the following general formula (4): 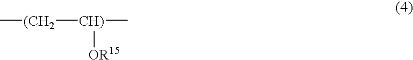
wherein R¹⁵ represents a hydrogen atom or is selected from —(CH(R¹⁶)—CH(R¹⁷)—O)ₚ—R¹⁸ and —(CH₂)ₘ—(O)ₙ—R¹⁸, where p is an integer of 1 to 18, m is an integer of 1 to 36, n is 0 or 1, R¹⁶ and R¹⁷ are, independently of each other, a hydrogen atom or CH₃, and R¹⁸ represents a hydrogen atom or a straight-chain, branched or cyclic alkyl group having 1 to 5 carbon atoms.

Specific examples of the hydrophilic repeating structural unit represented by the general formula (4) are mentioned below. However, the present invention is not limited at all by these.

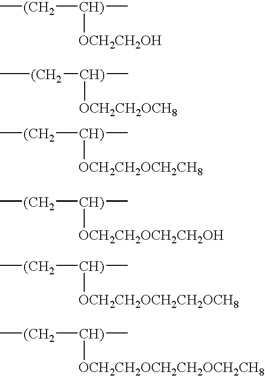

When a block segment containing at least one anionic repeating structural unit and at least one hydrophilic repeating structural unit is used in the present invention, the content of said at least one hydrophilic repeating structural unit is preferably 50 mol % or more, more preferably 80 mol % or more, still more preferably 90 mol % or more. If the content is less than 50 mol %, the interaction may overact, and the function may become insufficient in some cases. It is hence not preferable to contain the hydrophilic repeating structural unit in such a low content.

In order to prepare an amphiphilic block polymer using these repeating structural units of the polyalkenyl ethers though they are not limited to the above-mentioned examples, it may be obtained by, e.g., selecting and synthesizing a hydrophobic block segment and a hydrophilic block segment.

The ionic polymer used in the present invention may preferably have a molecular weight distribution, Mw (weight-average molecular weight)/Mn (number-average molecular weight), of 2.0 or less, which may more preferably be 1.6 or less, and still more preferably 1.3 or less.

The polymer used in the present invention may have a number-average molecular weight Mn of 2,000 or more, which may preferably be 3,000 or more, and should be not more than 1,000,000. If it has a number-average molecular weight Mn of less than 2,000, the dispersion stability of the coloring material may be deteriorated in some cases. The number-average molecular weight and weight-average molecular weight of the polymer in the present invention may be measured by volume exclusion chromatography (also called gel permeation chromatography, GPC).

The polymer used in the compositions according to the present invention may be in a content of from 0.1% by mass to 90% by mass, and preferably from 1% by mass to 50% by mass. If it is in a content of less than 0.1% by mass, the coloring material may be insufficiently dispersed or dissolved in the resulting ink. If it is in a content of more than 90% by mass, the resulting ink may have a too high viscosity.

In order to disperse the coloring material in the solvent in the first ink composition according to the present invention, the amphiphilic block polymer is used to form a self-assembled structure, whereby the coloring material can be enclosed by the polymer. Any changes of properties due to influence coming from external environment can be thereby inhibited. Also, in order for the coloring material to be improved in dispersion stability and be improved in enclosability (or includability), the block polymer may be more flexible in molecular motion. This is preferable because the polymer has sites where it becomes physically entangled with the coloring material to readily have an affinity therefor. Moreover, it may preferably be flexible also in that a coat layer can be formed with ease on a recording medium. For this end, the backbone chain of the block polymer may preferably have a glass transition temperature Tg of 20° C. or less, more preferably 0° C. or less, and still more preferably −20° C. or less. In this regard as well, the polymer having a polyvinyl ether structure may preferably be used because it has a low glass transition temperature and has flexible properties.

In particular, the ionic polymer contained in the first ink composition according to the present invention is preferably an amphiphilic block polymer. The amphiphilic block polymer can be obtained by, e.g., selecting and synthesizing a hydrophobic block segment and a hydrophilic block segment.

The block polymer used in the present invention may preferably have a molecular weight distribution, Mw (weight-average molecular weight)/Mn (number-average molecular weight), of 2.0 or less, which may more preferably be 1.6 or less, still more preferably 1.3 or less, and further preferably 1.2 or less.

The block polymer used in the present invention may have a number-average molecular weight Mn of 2,000 or more, which may preferably be 3,000 or more, and should be not more than 1,000,000. If it has a number-average molecular weight Mn of less than 2,000, the dispersion stability of the coloring material may be deteriorated in some cases. The number-average molecular weight and weight-average molecular weight of the polymer in the present invention may be measured by volume exclusion chromatography (also called gel permeation chromatography, GPC).

In the first ink composition according to the present invention, the coloring material may be enclosed by the block polymer as mentioned above. To form the state of enclosure, for example, a solution prepared by dissolving the coloring material in an organic solvent insoluble in water may be added to the micelle in water the block polymer compound forms and thereafter the organic solvent may be distilled off. Besides, the block polymer compound and the coloring material may be dissolved together or dispersed uniformly in an organic solvent and, in this state, this may be phase-inverted in an aqueous solvent so as to utilize a self-integrable process, to form the state of enclosure or inclusion. The residual solvent may be distilled off. Further, for example, a dispersion liquid prepared by dispersing a pigment in an organic solvent insoluble in water may be added to the micelle in water the block polymer forms, to form the state of enclosure.

In the first ink composition used in the present invention, micelle may be formed to cover the coloring material. As a result, it is reduced for the coloring material to come into direct contact with the air, so that the micelle may function as a protective layer. Specific examples thereof include scratch resistance. When a black pigment is used as the coloring material in the first ink composition, such an ink composition becomes excellent in fixing performance on a recording medium, particularly, on paper, and so it is expected to improve water fastness and line marker resistance upon printing because the polymer has a polyalkenyl ether structure relatively low in glass transition temperature.

The state of enclosure may be confirmed by instrumental analysis such as every kind of electron microscope analysis or X-ray diffraction. Also, in the case of the inclusion (enclosure) in the state of micelle, the coloring material separates from the solvent separately from the polymer under conditions of micelle collapse, and this enables indirect confirmation of the state of enclosure.

As described above, the block polymer compound may preferably form a micelle state. For this purpose as well, those which are amphiphilic are effective as the block polymer compounds used in the present invention. In this sense, the block polymer compound may more preferably have a polymer segment having an ionic repeating structural unit. It may preferably have, also in view of the necessity described later, the ionic repeating structural unit. This is preferable also for forming the state of enclosure. In the present invention, the block polymer may preferably be used from the viewpoints of the stability of dispersion, the enclosure of the coloring material, and various properties such as viscosity.

The second ink composition in the present invention will be described. The second ink composition is an ink comprising a polyvalent metal ion having reactivity with the block polymer compound contained in the first ink composition and a dye.

An inorganic substance may be added to the second ink composition, thereby forming a polyvalent metal ion exhibiting reactivity with the block polymer compound contained in the first ink composition. As examples of the inorganic substance, may be mentioned compounds having a hydroxyl group (—OH), such as magnesium hydroxide, potassium hydroxide and calcium hydroxide, and water-soluble polyvalent metal compounds such as magnesium nitrate, aluminum nitrate and calcium nitrate. However, the present invention is not limited by these compounds.

Specific examples of the polyvalent metal ion in the present invention include the following ions. However, the present invention is not limited by these ions.

Specifically, divalent cations such as Ca, Cu, Mg, Ni, Zn, Fe and Co, and trivalent cations such as Al, Nd, Y, Fe and La may be mentioned.

The polyvalent metal ion exhibiting reactivity with the block polymer contained in the first ink composition according to the present invention causes ion-exchange to replace a counter ion of an organic acid anion to cause a change in its solubility in an ink solvent. In general, ion exchange increasingly takes place as the valence of the ion increases. Accordingly, ion exchange is caused by adding an aqueous solution containing a calcium ion, magnesium ion or the like to an aqueous solution of an organic acid sodium salt, thereby forming an organic acid calcium salt to change the solubility. This change typically appears as a viscosity change in the ink. As a preferable mode, the viscosity is increased (thickened) to form gels.

The present invention typically concerns a recording method in which when two kinds of ink compositions are brought into contact with each other on a recording medium, at least the first ink composition reacts with the second ink composition to cause some change. The change is preferably a change in ionic nature, thereby causing changes in solubility, viscosity and the like. As a result, blurring between the two kinds of ink compositions is inhibited, and the drying speed is improved. More preferably, contact between the ink compositions causes an induction reaction, thereby modifying the polymer. A specific examples thereof is as follows.

As the first ink composition, is used a water-based dispersion ink in which a black pigment is enclosed by a micelle that the amphiphilic block polymer compound forms. The hydrophilic part of this block polymer is composed of a nonionic hydrophilic block and an anionic hydrophilic block. The anionic block is formed with a sodium salt of a carboxylic acid prepared at a pH of 9. As the second ink composition, is further used a yellow dye ink to which magnesium nitrate is added. In the present invention, the first ink composition and second ink composition are applied to adjoining areas, respectively, by means of an ink-jet method to come into liquid/liquid contact, whereupon an ion-exchange reaction takes place between a counter cation (in this case, Na cation) to the anion of the anionic repeating structural unit contained in the block polymer in the first ink composition and the polyvalent metal cation in the second ink composition. As a result, the micelle of the block polymer, in which the coloring material is enclosed, agglomerates, so that the first ink composition is thickened, and bleeding, i.e., color migration (or mixing) may less occur.

The amphiphilic block polymer used in the present invention has a block segment containing at least one hydrophilic repeating structural unit and at least one anionic repeating structural unit. Therefore, it is possible to enclose the coloring material in the micelle that the block polymer compound forms. Since the shell part has the hydrophilic repeating structural unit, the coloring material can be dispersed in an aqueous solvent. In other words, a coloring-material-enclosed ink composition can be formed. Further, since the shell part of the micelle also has the anionic repeating structural unit, polymer micelle particles, in which the coloring material is enclosed, also exhibit anionicity. Accordingly, agglomeration between the polymer micelle particles is inhibited by electrical repulsion, and so they can be stably dispersed in the solvent. Even when the ink compositions according to the present invention are applied to a recording medium by a thermal ink-jet recording system which causes heat energy to act on inks to effect bubbling to perform recording, or the like, the ink compositions can be stably ejected without causing precipitation, agglomeration and clogging at orifices.

When a polyvalent metal cation is added to such a first ink composition according to the present invention, an ion-exchange reaction takes place between the counter cation (for example, Na cation or K cation) to the anion of the coloring-material-enclosed micelle present in the first ink composition and the polyvalent metal cation. As a result, the block polymer micelle, in which the coloring material is enclosed, agglomerates. The amphiphilic block polymer compound in the present invention has the block segment containing at least one hydrophilic repeating structural unit and at least one anionic repeating structural unit. It is thus considered that since the anionic repeating structural unit is sparsely present, it is inhibited to agglomerate with the polyvalent metal cation in the micelle, thereby accelerating agglomeration between micelle particles, so that the coloring-material-enclosed block polymer micelle agglomerates upon contact of the first ink composition with the second ink composition, and the first ink composition is thickened to reduce bleeding, i.e., color migration (or mixing).

The content of the polyvalent metal ion having reactivity used in the second ink composition according to the present invention is from 0.1% by mass to 90% by mass, and preferably from 1% by mass to 50% by mass. If the content is less than 0.1% by mass, the reactivity with the first ink composition may be lowered in some cases. If the content is more than 90% by mass, the polyvalent metal ion may precipitate in the ink composition, or its viscosity may become too high.

The compositions in the present invention may also be incorporated with additives other than the foregoing, as exemplified by an antioxidant, a viscosity reducing agent, an ultraviolet absorber, a surface-active agent and a mildewproofing agent.

The ink compositions in the present invention also each contain a liquid medium. There are no particular limitations on the liquid medium to be contained in the ink compositions in the present invention. It is meant to be a liquid medium capable of dissolving, suspending or dispersing the components to be contained in the ink composition. In the present invention, water-insoluble organic solvents or water-soluble organic solvents such as various kinds of straight-chain, branched or cyclic aliphatic hydrocarbons, aromatic hydrocarbons and heterocyclic aromatic hydrocarbons, and water may be used as the liquid medium. Of course, a mixed solvent of any of these may also be used.

In particular, water and an aqueous liquid medium composed of water and a water-soluble organic solvent may preferably be used in the ink compositions in the present invention. As examples of the water-soluble organic solvent, it may include, e.g., polyhydric alcohols such as ethylene glycol, diethylene glycol, triethylene glycol, polyethylene glycol, propylene glycol, polypropylene glycol and glycerol; polyhydric alcohol ethers such as ethylene glycol monomethyl ether, ethylene glycol monoethyl ether, ethylene glycol monobutyl ether, diethylene glycol monoethyl ether and diethylene glycol monobutyl ether; and nitrogen-containing solvents such as N-methyl-2-pyrrolidone, substituted pyrrolidone and triethanolamine. Also, monohydric alcohols such as methanol, ethanol and isopropyl alcohol may also be used, and two or more of any of these may also be used in combination as occasion calls.

With regard to the pH of the aqueous liquid medium as well, the ink compositions may be used in all pH ranges, and may preferably be used in a pH range of from 1 to 14. The liquid medium used in the present invention may be in a content selected from a range of from 0.9% by mass to 99% by mass, and preferably from 10% by mass to 99% by mass. If it is in a content of less than 0.9% by mass, the resulting ink compositions may have too high viscosity. If it is in a content of more than 99% by mass, the coloring material may be unable to exhibit its coloring function sufficiently.

An ink-jet recording apparatus is described next, which is utilized upon embodying the image forming method according to the present invention. As the ink-jet recording apparatus, it is applicable to various ink-jet recording apparatus of a piezoelectric ink-jet recording system making use of piezoelectric elements, a thermal ink-jet recording system which causes heat energy to act on inks to effect bubbling to perform recording, and so forth.

This ink-jet recording apparatus is schematically described below with reference to FIGURE. Incidentally, FIGURE shows an example of construction to the end, which by no means limits the present invention.

FIGURE is a block diagram showing the construction of an ink-jet recording apparatus.

FIGURE shows a case in which a head is made to move to perform recording on a recording medium. As shown in FIGURE, to a CPU (central processing unit) 50 which controls the whole motion of the recording apparatus, an X-direction driving motor 56 and a Y-direction driving motor 58 which are to drive the head 70 in the X-Y directions are connected via an X-motor driving circuit 52 and a Y-motor driving circuit 54, respectively. According to instructions from the CPU 50, the X-direction driving motor 56 and the Y-direction driving motor 58 are driven through the X-motor driving circuit 52 and the Y-motor driving circuit 54, respectively, and the head 70 is then positioned in respect to the recording medium.

As shown in FIGURE, to the head 70, a head driving circuit 60 is connected in addition to the X-direction driving motor 56 and the Y-direction driving motor 58. The CPU 50 controls the head driving circuit 60 to drive the head 70, i.e., to eject an ink-jet recording ink. To the CPU 50, an X-encoder 62 and a Y-encoder 64 are further connected which are to detect the positions of the head, and the positional information of the head 70 is inputted thereto. A control program is also inputted into a program memory 66. The CPU 50 makes the head 70 move on the bases of this control program and the positional information sent from the X-encoder 62 and Y-encoder 64, and makes the head disposed at the desired position on the recording medium to eject the ink-jet recording ink. In this way, the desired images can be formed on the recording medium. Also, in the case of an image recording apparatus in which a plurality of ink-jet recording inks can be loaded, the operation as described above may be repeated given times in respect to the ink-jet recording inks, whereby the desired images can be formed on the recording medium.

After the ejection of the ink-jet recording ink, the head 70 may also optionally be moved to a position where a removing means (not shown) for removing excess ink having adhered to the head is disposed, to clean the head 70 by wiping or the like. As a specific method for such cleaning, a conventional method may be used as it is.

After images have been formed, the recording medium on which the images have been formed is replaced by a new recording medium by way of a recording medium transporting mechanism not shown.

Incidentally, in the present invention, the above embodiment may be modified or transformed as long as such modification or the like does not deviate from the gist of the present invention. For example, in the foregoing description, an example is shown in which the head 70 is moved in the directions of X-Y axes. This head 70 may instead be so made as to move only the X-axis direction (or the Y-axis direction) and the recording medium may be moved in the Y-axis direction (or the X-axis direction), to form images while moving these interlockingly.

The present invention brings a superior effect on a head having a means (e.g., an electricity-heat converter or a laser) for generating heat energy as the energy utilized in order to eject the ink-jet recording ink, and ejecting the ink-jet recording ink by the action of the heat energy. Such a system enables achievement of highly minute image formation. The use of the ink compositions according to the present invention as the inks enables much superior image formation.

As to typical construction and principles of the apparatus having such a means for generating heat energy, preferred are those which perform recording by using fundamental principles as disclosed in, e.g., U.S. Pat. No. 4,723,129 and No. 4,740,796. This system is applicable to any of what are called an on-demand type and a continuous type. In particular, in the case of the on-demand type, this system is effective because at least one driving signal which corresponds to ejection information and imparts rapid temperature rise that exceeds nucleate boiling may be applied to an electricity-heat converter in which a liquid is held and which is disposed correspondingly to a flow path, thereby generating heat energy in the electricity-heat converter to cause film boiling to take place on the heat-acting face of the head to consequently form in-liquid bubbles one to one corresponding to this driving signal. In virtue of the growth and contraction of such bubbles, the liquid is ejected through an opening for ejection to form at least one droplet. This driving signal may be pulse-shaped, as being more preferable because the bubbles are instantly appropriately grown and contracted and hence the ejection of liquid that has especially good response can be achieved. As this pulse-shaped driving signal, those like what are disclosed in U.S. Pat. No. 4,463,359 and U.S. Pat. No. 4,345,262 are suited. Incidentally, employment of conditions disclosed in U.S. Pat. No. 4,313,124 on invention concerned with the rate of temperature rise of the above heat-acting face enables performance of more superior ejection.

As the construction of the head, also applicable to the present invention are other construction than the construction as disclosed in the above U.S. Patents, in which ejection orifices, a liquid flow path and an electricity-heat converter are combined (a linear liquid flow path or a perpendicular liquid flow path). Namely, the construction making reference to U.S. Pat. No. 4,558,333 and U.S. Pat. No. 4,459,600, which disclose a construction in which a heat-acting portion is disposed in a bent region, may also be applicable to the present invention. Besides, the construction disclosed in Japanese Patent Applications Laid-open No. S59-123670 and No. S59-138461 may also be applicable to the present invention. These patent applications disclose a construction in which a slit common to a plurality of electricity-heat converters is provided as an ejection port of the electricity-heat converters, and a construction in which an opening through which the pressure wave of heat energy is absorbed is made to correspond to an ejection port, respectively. In other words, whatever form the head has, the ink-jet recording ink can be ejected surely and in a good efficiency according to the present invention.

The present invention may effectively be further applied to a full-line type head having a length corresponding to the maximum width of a recording medium in the image forming apparatus of the present invention. Such a head may have either of construction which satisfies such length by combination of a plurality of heads and construction made as one head formed integrally.

In addition, the present invention is effective also when, even in a serial type one, a head fixed to the apparatus main body is used, or a replaceable chip type head is used which is fitted to the apparatus main body to enable electrical connection with the apparatus main body or feed of ink from the apparatus main body.

The apparatus of the present invention may further have a droplet removing means. Where it is provided with such a means, a much superior ejection effect can be materialized.

As the construction of the apparatus of the present invention, a preliminary auxiliary means and so forth may also additionally be provided. This is preferable because the effect brought by the present invention can be made more stable. To give examples specifically, such means may include a capping means for the head, a pressurizing or sucking means, a preliminary heating means and a preliminary ejection means.

What is most effective for the present invention is that which carries out the film bubbling system described above.

In the apparatus of the present invention, the ink ejected from each ejection orifice of the head which ejects the ink-jet recording ink may preferably be in an amount ranging from 0.1 picoliter to 100 picoliters.

The inks as the liquid compositions in the present invention may also be used in an indirect recording apparatus making use of a recording system in which the inks are applied to an intermediate transfer material and thereafter transferred to a recording medium such as paper. They may still also be applied to an apparatus making use of an intermediate transfer material handled by a direct recording system.

### EXAMPLES

The present invention is described below in greater detail by giving Examples. The present invention is by no means limited to these Examples.

### Example 1

Synthesis of Polymer:

<Synthesis of Block Polymer 1; di-block Polymer, Poly[TolOVE-b-(MOEOVE-r-VEEtPhCOONa)] composed of 2-(4-methylbenzeneoxy)ethyl vinyl ether (TolOVE: A-block), and Diethylene Glycol Methyl Vinyl Ether and Sodium 4-(2-vinyloxy)ethoxybenzoate (MOEOVE-r-VEEtPhCOONa; B-Block)> (here, b and r are Notations Indicating a Block Polymer and a Random Polymer, Respectively)

The inside atmosphere of a glass container fitted with a three-way cock was displaced with nitrogen, and the container was then heated to 250° C. in the atmosphere of nitrogen gas to remove adsorbed water. After the system was returned to room temperature, 2.5 mmols (millimols) of TolOVE, 16 mmols of ethyl acetate, 0.05 mmol of 1-isobutoxyethyl acetate and 11 ml of toluene were added, and the reaction system was cooled. At the time the temperature in the system reached 0° C., 0.2 mmol of ethylaluminum sesquichloride (an equimolar mixture of diethylaluminum chloride and ethylaluminum dichloride) was added to initiate polymerization. Molecular weight was periodically monitored using gel permeation chromatography (GPC), where the polymerization for the A-block was confirmed to have been completed.

After 2.5 mmols of MOEOVE and 1.5 mmols of ethyl 4-(2-vinyloxy)ethoxybenzoate were then added as B-block components, and completion of the polymerization for the MOEOVE monomer was confirmed by monitoring using GPC, the polymerization reaction was stopped. To stop the polymerization reaction, an aqueous 0.3% by mass ammonia/methanol solution was added to the system. The reaction mixture solution obtained was diluted with dichloromethane, followed by washing with 0.6 mol/L hydrochloric acid three times and subsequently with distilled water three times. The organic layer obtained was concentrated and evaporated to dryness by means of an evaporator, and this was vacuum-dried. The vacuum-dried product was repeatedly dialyzed in a methanol solvent by the use of a cellulose semipermeable membrane to remove monomeric compounds, thus the intended di-block polymer was obtained. The compound was identified by means of NMR and GPC. As a result, the compound was found to have a Mn of 19,200 and Mw/Mn of 1.30. The polymerization ratio of A:B was 100:60. The polymerization ratio between the two monomers in the B-block was MOEOVE: ethyl 4-(2-vinyloxy)ethoxybenzoate=50:10.

Then, 26 parts by mass of this block polymer was stirred at 0° C. for 3 days together with 200 parts by mass of an aqueous sodium hydroxide solution with pH 13 to make up a sodium carboxylate polymer solution. Dialysis was carried out to remove excess sodium hydroxide, followed by drying, and then the solvent was evaporated off to isolate a sodium carboxylate type AB block polymer.

Five parts by mass of this di-block polymer was added to 20 parts by mass of ion-exchanged water containing sodium hydroxide to adjust its pH to 7.8, thereby dispersing the polymer in the water using an ultrasonic homogenizer. The dispersion obtained was filtered under pressure through a filter of 1 μm in pore size to prepare a dispersion liquid. When 6N hydrochloric acid was added dropwise to the dispersion liquid, this dispersion liquid thickened. From the result of measuring the IR spectra of the dispersion liquid before and after the dropping addition, it was found that the carboxylate ion of the B-segment was converted to a carboxylic acid.

<Synthesis of Block Polymer 2; Di-Block Polymer, Poly[PhOVE-b-(MOEOVE-r-VEEtPhCOONa)] Composed of 2-phenoxyethyl Vinyl Ether (PhOVE: A-block), and Diethylene Glycol Methyl Vinyl Ether and Sodium 4-(2-vinyloxy)ethoxy-benzoate (MOEOVE-r-VEEtPhCOONa; B-Block)> (Here, b and r are Notations Indicating a Block Polymer and a Random Polymer, Respectively)

A di-block polymer, Poly[PhOVE-b-(MOEOVE-r-VEEtPhCOONa)], was synthesized in the same manner as described above except that 2.5 mmols of PhOVE was used in place of 2.5 mmols of TolOVE of the A-block component. The compound was identified by means of NMR and GPC. As a result, the compound was found to have a Mn of 17,800 and Mw/Mn of 1.31. Here, Mn and Mw indicate a number-average molecular weight and a weight-average molecular weight, respectively. The other synthesizing conditions were the same as those in Block Polymer 1. The polymerization ratio of A:B was 100:60. The polymerization ratio between the two monomers in the B-block was MOEOVE: ethyl 4-(2-vinyloxy)ethoxybenzoate=50:10.

Then, 26 parts by mass of this block polymer was stirred at 0° C. for 3 days together with 200 parts by mass of an aqueous sodium hydroxide solution with pH 13 to make up a sodium carboxylate polymer solution. Dialysis was carried out to remove excess sodium hydroxide, followed by drying, and then the solvent was evaporated off to isolate a sodium carboxylate type AB block polymer.

Five parts by mass of this di-block polymer was added to 20 parts by mass of ion-exchanged water containing sodium hydroxide to adjust its pH to 7.8, thereby dispersing the polymer in the water using an ultrasonic homogenizer. The dispersion obtained was filtered under pressure through a filter of 1 μm in pore size to prepare a dispersion liquid. When 6N hydrochloric acid was added dropwise to the dispersion liquid, this dispersion liquid thickened. From the result of measuring the IR spectra of the dispersion liquid before and after the dropping addition, it was found that the carboxylate ion of the B-segment was converted to a carboxylic acid.

<Synthesis of Block Polymer 3; Tri-Block Polymer, Poly[TolOVE-b-MOEOVE-b-(MOEOVE-r-VEEtPhCOONa)] Composed of 2-(4-methylbenzeneoxy)Ethyl Vinyl Ether (TolOVE: A-Block), Diethylene Glycol Methyl Vinyl Ether (MOEOVE: B-Block), and Diethylene Glycol Methyl Vinyl Ether and Sodium 4-(2-vinyloxy)ethoxybenzoate (MOEOVE-r-VEEtPhCOONa; C-Block)> (Here, b and r are Notations Indicating a Block Polymer and a Random Polymer, Respectively)

The inside atmosphere of a glass container fitted with a three-way cock was displaced with nitrogen, and the container was then heated to 250° C. in the atmosphere of nitrogen gas to remove adsorbed water. After the system was returned to room temperature, 5.0 mmols of TolOVE, 16 mmols of ethyl acetate, 0.05 mmol of 1-isobutoxyethyl acetate and 11 ml of toluene were added, and the reaction system was cooled. At the time the temperature in the system reached 0° C., 0.2 mmol of ethylaluminum sesquichloride (an equimolar mixture of diethylaluminum chloride and ethylaluminum dichloride) was added to initiate polymerization. Molecular weight was periodically monitored using gel permeation chromatography (GPC), where the polymerization for the A-block was confirmed to have been completed.

Next, 1.25 mmols of MOEOVE was added as a B-block component to continue polymerization. After completion of the polymerization for the B-block component was confirmed by monitoring using GPC, 1.25 mmols of MOEOVE and 1.5 mmols of ethyl 4-(2-vinyloxy)ethoxybenzoate were added as C-block components to continue polymerization. After completion of the polymerization for the MOEOVE monomer was confirmed by monitoring using GPC, the polymerization reaction was stopped. To stop the polymerization reaction, an aqueous 0.3% by mass ammonia/methanol solution was added to the system. The reaction mixture solution obtained was diluted with dichloromethane, followed by washing with 0.6 mol/L hydrochloric acid three times and subsequently with distilled water three times. The organic layer obtained was concentrated and evaporated to dryness by means of an evaporator, and this was vacuum-dried. The vacuum-dried product was repeatedly dialyzed in a methanol solvent by the use of a cellulose semipermeable membrane to remove monomeric compounds, thus the intended tri-block polymer was obtained. The compound was identified by means of NMR and GPC. As a result, the compound was found to have a Mn of 18,100 and Mw/Mn of 1.32. The polymerization ratio of A:B:C was 100:25:35. The polymerization ratio between the two monomers in the C-block was MOEOVE ethyl 4-(2-vinyloxy)ethoxybenzoate=25:10.

Then, 26 parts by mass of this block polymer was stirred at 0° C. for 3 days together with 200 parts by mass of an aqueous sodium hydroxide solution with pH 13 to make up a sodium carboxylate polymer solution. Dialysis was carried out to remove excess sodium hydroxide, followed by drying, and then the solvent was evaporated off to isolate a sodium carboxylate type ABC block polymer.

Five parts by mass of this tri-block polymer was added to 20 parts by mass of ion-exchanged water containing sodium hydroxide to adjust its pH to 7.8, thereby dispersing the polymer in the water using an ultrasonic homogenizer. The dispersion obtained was filtered under pressure through a filter of 1 μm in pore size to prepare a dispersion liquid. When 6N hydrochloric acid was added dropwise to the dispersion liquid, this dispersion liquid thickened. From the result of measuring the IR spectra of the dispersion liquid before and after the dropping addition, it was found that the carboxylate ion of the C-segment was converted to a carboxylic acid.

<Synthesis of Block Polymer 4; Tri-Block polymer, Poly[TolOVE-b-MOEOVE-b-VEEtPhPhCOONa] Composed of 2-(4-methylbenzeneoxy)ethyl Vinyl Ether (TolOVE: A-block), Diethylene Glycol Methyl Vinyl Ether (MOEOVE: B-Block) and Sodium 4′-(2-vinyloxyethoxy)-biphenyl-4-carboxylate (VEEtPhPhCOONa; C-block)> (Here, b is a Notation Indicating a Block Polymer)

The inside atmosphere of a glass container fitted with a three-way cock was displaced with nitrogen, and the container was then heated to 250° C. in the atmosphere of nitrogen gas to remove adsorbed water. After the system was returned to room temperature, 5.0 mmols of TolOVE, 16 mmols of ethyl acetate, 0.05 mmol of 1-isobutoxyethyl acetate and 11 ml of toluene were added, and the reaction system was cooled. At the time the temperature in the system reached 0° C., 0.2 mmol of ethylaluminum sesquichloride (an equimolar mixture of diethylaluminum chloride and ethylaluminum dichloride) was added to initiate polymerization. Molecular weight was periodically monitored using gel permeation chromatography (GPC), where the polymerization for the A-block was confirmed to have been completed.

Next, 2.5 mmols of MOEOVE was added as a B-block component to continue polymerization. After completion of the polymerization for the B-block component was confirmed by monitoring using GPC, 5.0 mmols of ethyl 4′-(2-vinyloxyethoxy)-biphenyl-4-carboxylate was added as a C-block component to continue polymerization. After 3 hours, the polymerization reaction was stopped. To stop the polymerization reaction, an aqueous 0.3% by mass ammonia/methanol solution was added to the system. The reaction mixture solution obtained was diluted with dichloromethane, followed by washing with 0.6 mol/L hydrochloric acid three times and subsequently with distilled water three times. The organic layer obtained was concentrated and evaporated to dryness by means of an evaporator, and this was vacuum-dried. The vacuum-dried product was repeatedly dialyzed in a methanol solvent by the use of a cellulose semipermeable membrane to remove monomeric compounds, thus the intended tri-block polymer was obtained.

The compound was identified by means of NMR and GPC. As a result, the compound was found to have a Mn of 19,200 and Mw/Mn of 1.31. The polymerization ratio of A:B:C was 100:50:10.

Then, 26 parts by mass of this block polymer was stirred at 0° C. for 3 days together with 200 parts by mass of an aqueous sodium hydroxide solution with pH 13 to make up a sodium carboxylate polymer solution. Dialysis was carried out to remove excess sodium hydroxide, followed by drying, and then the solvent was evaporated off to isolate a sodium carboxylate type ABC block polymer.

Five parts by mass of this tri-block polymer was added to 20 parts by mass of ion-exchanged water containing sodium hydroxide to adjust its pH to 7.8, thereby dispersing the polymer in the water using an ultrasonic homogenizer. The dispersion obtained was filtered under pressure through a filter of 1 μm in pore size to prepare a dispersion liquid. When 6N hydrochloric acid was added dropwise to the dispersion liquid, this dispersion liquid thickened. From the result of measuring the IR spectra of the dispersion liquid before and after the dropping addition, it was found that the carboxylate ion of the C-segment was converted to a carboxylic acid.

<Synthesis of Block Polymer 5; Di-Block Polymer, Poly[TolOVE-b-(MOEOVE-r-VEEtPhPhCOONa)] Composed of 2-(4-methylbenzeneoxy)ethyl Vinyl Ether (TolOVE: A-Block), and Diethylene Glycol Methyl Vinyl Ether and Sodium 4′-(2-vinyloxyethoxy)-biphenyl-4-carboxylate ((MOEOVE-r-VEEtPhPhCOONa; B-Block)> (Here, b and r are Notations Indicating a Block Polymer and a Random Polymer, Respectively)

A di-block polymer, Poly[TolOVE-b-(MOEOVE-r-VEEtPhPhCOONa)], was synthesized in the same manner as in Block Polymer 1 except that 1.5 mmols of ethyl 4′-(2-vinyloxyethoxy)-biphenyl-4-carboxylate was used in place of 1.5 mmols of 4-(2-vinyloxy)ethoxybenzoate that is one of the B-block components in Block Polymer 1. The compound was identified by means of NMR and GPC. As a result, the compound was found to have a Mn of 19,900 and Mw/Mn of 1.29. The polymerization ratio of A:B was 100:60. The polymerization ratio between the two monomers in the B-block was MOEOVE: ethyl 4′-(2-vinyloxyethoxy)-biphenyl-4-carboxylate=50:10.

Then, 26 parts by mass of this block polymer was stirred at 0° C. for 3 days together with 200 parts by mass of an aqueous sodium hydroxide solution with pH 13 to make up a sodium carboxylate polymer solution. Dialysis was carried out to remove excess sodium hydroxide, followed by drying, and then the solvent was evaporated off to isolate a sodium carboxylate type AB block polymer.

Five parts by mass of this di-block polymer was added to 20 parts by mass of ion-exchanged water containing sodium hydroxide to adjust its pH to 7.8, thereby dispersing the polymer in the water using an ultrasonic homogenizer. The dispersion obtained was filtered under pressure through a filter of 1 μm in pore size to prepare a dispersion liquid. When 6N hydrochloric acid was added dropwise to the dispersion liquid, this dispersion liquid thickened. From the result of measuring the IR spectra of the dispersion liquid before and after the dropping addition, it was found that the carboxylate ion of the B-segment was converted to a carboxylic acid.

<Preparation of Inks>

First Ink Composition:

A plurality of inks were prepared by separately using plural kinds of block polymers. More specifically, 3 parts by mass of a black pigment (RAVEN 1060), and 5 parts by mass of each of the above-described Black Polymer 1, Black Polymer 2, Black Polymer 3, Black Polymer 4 and Black Polymer 5 were respectively weighed. To each of mixtures obtained by adding each of the block polymers to the pigment, were added 15 parts by mass of diethylene glycol and 178 parts by mass ion-exchanged water, followed by dispersion using an ultrasonic homogenizer. The resultant was filtered under pressure through a filter of 1 μm in pore size to prepare a pigment dispersed water-based ink. The pigment showed good dispersibility in all inks.

The above ink compositions were each set on TEM grids (a cryotransfer system) equipped with an energy filter to freeze the aqueous solution to make electron microscopic observation. As the result, only spherical micelle particles were observed, and it was seen that the coloring material stood enclosed completely in the block polymer.

Second Ink Composition:

Three parts by mass of C.I. Acid Red 52 that is an acid dye, 6 parts by mass of trimethylolpropane, 6 parts by mass of glycerol, 6 parts by mass of 2-pyrrolidone, 3 parts by mass of magnesium nitrate and a balanced amount of ion-exchanged water were added to one another, followed by uniform dissolution using an ultrasonic homogenizer. The solution obtained was filtered under pressure through a filter of 3.0 μm in pore size to prepare an acid water-based dye ink (magenta ink).

### Example 2

Using one of the first ink compositions and the second ink composition, ink-jet recording was performed. Ink tanks of an ink-jet printer (trade name: BJF800, manufactured by CANON INC.) were filled with the two kinds of ink compositions, and a pattern formed alternately of black and magenta colors at intervals of 1 mm was recorded on plain paper. As the result, the black and magenta colors were seen to have little blurred at their boundaries. As a result of observation with a microscope, blurs were found to be as follows. In the case where Block Polymers 1, 2, 3, 4 and 5 each were used as the block polymer compound, blurs were 0.14 mm, 0.14 mm, 0.14 mm, 0.13 mm and 0.13 in width on the average in that order.

After 30 seconds from completion of the printing, a recorded area was strongly pushed with a finger. As a result, no ink adhered to the finger in each case. At the same time, line marker resistance was evaluated with a water-based line marker. As a result, the colors came to scarcely blur. Thus, the line marker resistance was good.

### Comparative Example 1

Three parts by mass of C.I. Acid Red 52 that is an acid dye, 6 parts by mass of trimethylolpropane, 6 parts by mass of glycerol, 6 parts by mass of 2-pyrrolidone, and a balanced amount of ion-exchanged water were added to one another, followed by uniform dissolution using an ultrasonic homogenizer. The solution obtained was filtered under pressure through a filter of 3.0 μm in pore size to prepare an acid water-based dye ink (magenta ink), which is a second ink composition. Using one of the black inks (first ink compositions) prepared in Example 1 and the second ink composition, a printing test was conducted in the same manner as in Example 2. As the result, the black and magenta colors were visually seen to have clearly blurred at their boundaries. As a result of observation with a microscope, blurs were found to be 0.36 mm in width on the average in each case. After 30 seconds from completion of the printing, a recorded area was strongly pushed with a finger. As a result, inks adhered to the finger in each case. At the same time, line marker resistance was evaluated with a water-based line marker. As a result, the black color came to conspicuously blur. It is considered that drying was insufficient in 30 seconds.

### Comparative Example 2

First Ink:

Three parts by mass of a black pigment (RAVEN 1060) and 5 parts by mass of a styrene-sodium acrylate block polymer (1:1 copolymer, number-average molecular weight: 6,300, weight-average molecular weight: 9,200) were mixed with 15 parts by mass of diethylene glycol and 178 parts by mass ion-exchanged water, followed by dispersion using an ultrasonic homogenizer. The resultant was filtered under pressure through a filter of 1 μm in pore size to prepare a pigment dispersed water-based ink. The pigment showed good dispersibility.

Second Ink:

A magenta ink furnished in an ink jet printer BJF800 was used.

A pattern formed alternately of both colors at intervals of 1 mm was recorded on plain paper in the same manner as in Example 2. As the result, both the colors were visually seen to have blurred at their boundaries. As a result of observation with a microscope, blurs were found to be 0.28 mm in width on the average. At the same time, line marker resistance was evaluated with a water-based line marker. As a result, the black color came to conspicuously blur. It is considered that drying was insufficient in 30 seconds.

### Example 3

A di-block polymer composed of isobutyl vinyl ether and 2-vinyloxy-1-biphenyloxyethyl (A-block components), and magnesium 4-(2-vinyloxyethoxy)benzenesulfonate (B-block component) was synthesized in the same manner as described above (polymerization ratio: A/B=100/15; number-average molecular weight: 14,800; and weight-average molecular weight: 18,500, all before hydrolysis). The pKa of acid of this polymer was −0.81.

Seven parts by mass of a styrene-sodium acrylate block polymer (1:1 copolymer, number-average molecular weight: 6,300, weight-average molecular weight: 9,200), 7 parts by mass of a black pigment (trade name: MOGUL-L, available from Cabot Corp.), 40 parts by mass of ethylene glycol and 200 parts by mass of distilled water were dispersed using an ultrasonic homogenizer. The dispersion obtained was filtered under pressure through a filter of 1 μm in pore size, and its pH was adjusted to 9.3 to prepare a pigment dispersed water-based ink.

A dye ink composition with pH 4.8 was obtained from 1.5 parts by mass of sodium azulenesulfonate that is a blue water-soluble dye, 10 parts by mass of ethylene glycol, 10 parts by mass of diethylene glycol, 3 parts by mass of the di-block polymer prepared above and 77.5 parts by weight of distilled water.

A pattern formed alternately of both colors at intervals of 1 mm was recorded on plain paper in the same manner as in Example 2. As a result of observation with a microscope, blurs at boundaries between both colors were found to be 0.20 mm in width on the average.

Immediately after the printing, a recorded pattern was also wetted with 10 ml of distilled water over an area of about 50 cm². As the result, the colors only slightly came to blur and migrate.

The above pigment dispersed ink composition was set on TEM grids (a cryotransfer system manufactured by FEI Company) to freeze the aqueous solution to make electron microscopic observation. As the result, 60 percent of the particles had bare pigments.

### Example 4

A di-block polymer (4-1) composed of isobutyl vinyl ether and 2-vinyloxy-1-biphenyloxyethyl (A-block components), and sodium 5-(2-vinyloxyethoxy)benzene-1,3-dicarboxlate (B-block component) was synthesized in the same manner as described above (polymerization ratio: A/B=100/15; number-average molecular weight: 15,000; and weight-average molecular weight: 18,200, all before hydrolysis). The pKa of acid of this polymer was 4.19.

Next, a di-block polymer (4-2) composed of isobutyl vinyl ether and 2-vinyloxy-1-biphenyloxyethyl (A-block components), and magnesium 4-(2-vinyloxy-2,3,5,6-tetrafluorobenzoate (B-block component) was synthesized in the same manner as described above (polymerization ratio: A/B=100/17; number-average molecular weight: 16,000; and weight-average molecular weight: 19,900, all before hydrolysis). The pKa of acid of this polymer was 1.97.

Fifteen parts by mass of the di-block polymer obtained in such a manner and 7 parts by mass of a black pigment (trade name: MOGUL-L, available from Cabot Corp.) were mixed into 150 parts by mass of dimethylformamide, followed by addition of 500 parts by mass of distilled water and KOH in an amount of 1 equivalent mass based on the carboxylic acid moieties of the block polymer to obtain a black ink composition.

A dye ink composition with pH 5.1 was obtained from 1.5 parts by mass of sodium azulenesulfonate that is a blue water-soluble dye, 10 parts by mass of ethylene glycol, 10 parts by mass of diethylene glycol, 3 parts by mass of the di-block polymer (4-2) and 77.5 parts by mass of distilled water.

A pattern formed alternately of both colors at intervals of 1 mm was recorded on plain paper in the same manner as in Example 1. As a result of observation with a microscope, blurs at boundaries between both colors were found to be 0.12 mm in width on the average.

Immediately after the printing, a recorded pattern was also wetted with 10 ml of distilled water over an area of about 50 cm². As the result, the colors were not seen to come to blur or migrate.

The above pigment dispersed ink composition was set on TEM grids (a cryotransfer system manufactured by FEI Company) to freeze the aqueous solution to make electron microscopic observation. As the result, only spherical particles were observed, and it was seen that the coloring material stood enclosed completely in the block polymer.

This application claims priority from Japanese Patent Application No. 2004-062968 filed Mar. 5, 2004, Japanese Patent Application No. 2004-376606 filed Dec. 27, 2004 and Japanese Patent Application No. 2005-341119 filed Nov. 25, 2005 which are hereby incorporated by reference herein.

What is claimed is:

1. An image forming method, in which at least two kinds of ink compositions are applied onto a recording medium to form an image on the recording medium; the method comprising the steps of:
providing a first ink composition containing a solvent, a coloring material and a block polymer having at least an anionic block segment for dispersing the pigment in the solvent, and a second ink composition containing a solvent, a dye and a polyvalent metal ion having reactivity with the block polymer; and
applying the first ink composition and the second ink composition onto the recording medium to bring the first ink composition into contact with the second ink composition.

2. The image forming method according to claim 1, wherein the block polymer has a polyalkenyl ether backbone chain in its repeating structural unit.

3. The image forming method according to claim 1, wherein the block polymer has at least 3 block segments.

4. The image forming method according to claim 1, wherein the block polymer encloses the coloring material.

5. The image forming method according to claim 1, wherein the block polymer has a hydrophilic repeating structural unit.

6. The image forming method according to claim 1, wherein the block polymer is amphiphilic.

7. The image forming method according to claim 2, wherein the block polymer has, as the repeating structural unit having the polyalkenyl ether backbone chain, a structure represented by the following general formula (1):
—(CRₐR_{b}—CR_{c}(OR₁)) (1)
wherein Rₐ, R_{b} and R_{c} are, independently of one another, H or CH₃, and R₁ represents a straight-chain, branched or cyclic alkyl group having 1 to 18 carbon atoms, or is selected from —(CH(R₂)—CH(R₃)—O)₁—R₄ and —(CH₂)ₘ—(O)ₙ—R₄; where l and m are, independently of each other, selected from integers of 1 to 12, n is 0 or 1, R₂ and R₃ are, independently of each other, H or CH₃, and R₄ represents H, a straight-chain, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR₅, -PhCOOR₅ or —R₆COOR₅, with the proviso that when R₄ is other than a hydrogen atom, a hydrogen atom on a carbon atom may be replaced by a straight-chain or branched alkyl group having 1 to 4 carbon atoms, and a carbon atom in the aromatic ring may be replaced by a nitrogen atom, R₅ is H, Na or K, and R₆ is a polycyclic aromatic substituent group.

8. The image forming method according to claim 1, wherein said first and second ink compositions are applied onto the recording medium by employing an ink-jet recording system.

9. An ink set for applying at least two kinds of ink compositions onto a recording medium to form an image on the recording medium, the ink set comprising:
a first ink composition containing a solvent, a pigment and a block polymer having at least an anionic block segment for dispersing the coloring material in the solvent; and
a second ink composition containing a solvent, a dye and a polyvalent metal ion having reactivity with the block polymer.

10. The ink set according to claim 9, wherein the solvent is an aqueous solvent.

11. An image forming apparatus comprising:
an ink-applying means for causing energy to act on each of a first ink composition containing a solvent, a coloring material and a block polymer having at least an anionic block segment for dispersing the pigment in the solvent, and a second ink composition containing a solvent, a dye and a polyvalent metal ion having reactivity with the block polymer to apply the ink compositions to a recording medium, thereby forming an image; and
a driving means for driving the ink-applying means.
